(19) United States
(12) Patent Application Publication
(10) Pub. No.: US 2026/0020614 A1
(43) Pub. Date: Jan. 22, 2026

(54) AEROSOL-GENERATING DEVICE

(71) Applicant: KT&G CORPORATION, Daejeon (KR)

(72) Inventors: Dongsung KIM, Seoul (KR); Youngbum KWON, Yongin-si (KR); Yonghwan KIM, Anyang-si (KR); Hwikyeong AN, Seoul (KR)

(73) Assignee: KT&G CORPORATION, Daejeon (KR)

(21) Appl. No.: 19/241,572

(22) Filed: Jun. 18, 2025

(30) Foreign Application Priority Data
Jul. 22, 2024 (KR) 10-2024-0096205

(51) Int. Cl. A24F 40/46; A24F 40/51

(52) U.S. Cl. CPC A24F 40/46; A24F 40/51

(57) ABSTRACT

An aerosol-generating device is disclosed. The aerosol-generating device includes a body including an insertion space with one side open, a heater configured to heat the insertion space, at least one sensor disposed adjacent to the insertion space, a circuit board on which the at least one sensor is disposed, and a heat spreader in contact with the circuit board. At least a portion of the heat spreader extends in a direction away from the heater.

### CROSS-REFERENCE TO RELATED APPLICATION

This application claims priority from Korean Patent Application No. 10-2024-0096205, filed on Jul. 22, 2024, in the Korean Intellectual Property Office, the disclosure of which is incorporated herein by reference in its entirety.

### BACKGROUND OF THE DISCLOSURE

### 1. Field of the Disclosure

The present disclosure relates to an aerosol-generating device.

### 2. Description of the Related Art

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

An aerosol-generating device uses a blade- or rod-shaped internal heater, which is inserted into an aerosol-generating substance to heat the aerosol-generating substance, or a cylindrical external heater, which accommodates an aerosol-generating substance to heat the aerosol-generating substance.

Heat generated by the heater is transferred to the outside of the heater. In conventional aerosol-generating devices, the temperatures of sensors provided in the device increase due to heat transferred to the outside of the heater, which may cause malfunction or failure of the sensors.

### SUMMARY OF THE DISCLOSURE

It is an object of the present disclosure to solve the above and other problems.

It is another object of the present disclosure to provide an aerosol-generating device including a heat spreader that is in contact with a circuit board connected to at least one sensor and extends in a direction away from a heater.

It is still another object of the present disclosure to provide an aerosol-generating device in which the heat spreader is disposed in contact with a surface of the circuit board opposite a surface on which sensors are disposed.

It is still another object of the present disclosure to provide an aerosol-generating device in which the heat spreader is bent in a shape corresponding to the bent shape of the circuit board.

It is still another object of the present disclosure to provide an aerosol-generating device in which the heat spreader extends to a lower position than the heater.

It is still another object of the present disclosure to provide an aerosol-generating device in which the heat spreader is disposed adjacent to an inflow passage.

It is still another object of the present disclosure to provide an aerosol-generating device including at least one heat sink disposed outside the heat spreader.

It is still another object of the present disclosure to provide an aerosol-generating device including a thermal interface material (TIM) that is disposed between the heat spreader and a body casing and is in contact with the heat spreader and the body casing.

In accordance with an aspect of the present disclosure for accomplishing the above and other objects, there is provided an aerosol-generating device including a body including an insertion space with one side open, a heater configured to heat the insertion space, at least one sensor disposed adjacent to the insertion space, a circuit board on which the at least one sensor is disposed, and a heat spreader in contact with the circuit board, wherein at least a portion of the heat spreader extends in a direction away from the heater.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF THE DRAWINGS

The above and other objects, features, and other advantages of the present disclosure will be more clearly understood from the following detailed description taken in conjunction with the accompanying drawings, in which:

FIGS. 1 and 2 are views showing an aerosol-generating device according to embodiments of the present disclosure;

FIG. 3 is a front perspective view of an aerosol-generating device according to an embodiment of the present disclosure;

FIG. 4 is an exploded perspective view of a heater assembly of the aerosol-generating device according to the embodiment of the present disclosure;

FIG. 5 is a cross-sectional view of the heater assembly of the aerosol-generating device according to the embodiment of the present disclosure;

FIG. 6 is a view showing an electrically conductive track of the heater assembly according to the embodiment of the present disclosure;

FIG. 7 is a cross-sectional view of an aerosol-generating device according to an embodiment of the present disclosure when viewed from the front;

FIG. 8 is a perspective view showing a state in which a circuit board, a heat spreader, and a thermal interface material (TIM) are coupled in the aerosol-generating device according to the embodiment of the present disclosure;

FIG. 9 is a perspective view showing a state in which the circuit board, the heat spreader, and the TIM are separated in the aerosol-generating device according to the embodiment of the present disclosure;

FIG. 10 is a cross-sectional view of the aerosol-generating device according to the embodiment of the present disclosure when viewed from side;

FIG. 11 is a cross-sectional view of the aerosol-generating device according to the embodiment of the present disclosure when viewed from above;

FIG. 12 is a cross-sectional view of an aerosol-generating device according to another embodiment of the present disclosure when viewed from the front;

FIG. 13 is a perspective view showing a state in which a circuit board, a heat spreader, and a TIM are coupled in the aerosol-generating device according to the other embodiment of the present disclosure;

FIG. 14 is a perspective view showing a state in which the circuit board, the heat spreader, and the TIM are separated in the aerosol-generating device according to the other embodiment of the present disclosure;

FIG. 15 is a cross-sectional view of the aerosol-generating device according to the other embodiment of the present disclosure when viewed from side; and

FIG. 16 is a block diagram of an aerosol-generating device according to an embodiment of the present disclosure.

### DETAILED DESCRIPTION OF THE PREFERRED EMBODIMENTS

Hereinafter, the embodiments disclosed in the present specification will be described in detail with reference to the accompanying drawings, and the same or similar elements are denoted by the same reference numerals Even if they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Throughout this specification, the directions of an aerosol-generating device 1 may be defined based on an orthogonal coordinate system. In the orthogonal coordinate system, an x-axis direction may be defined as a leftward-rightward direction of the aerosol-generating device 1. A y-axis direction may be defined as a forward-backward direction of the aerosol-generating device 1. A z-axis direction may be defined as an upward-downward direction of the aerosol-generating device 1.

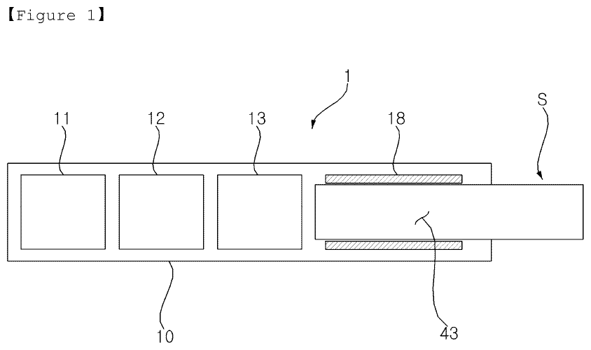

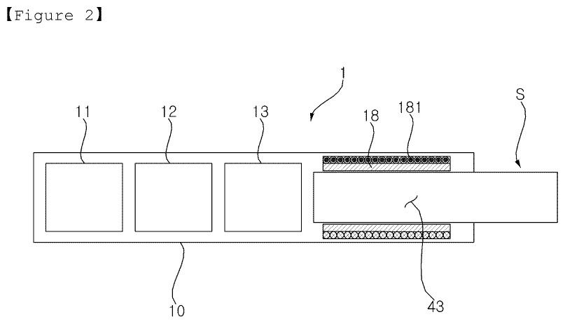

FIGS. 1 and 2 are views showing an aerosol-generating device 1 according to embodiments of the present disclosure.

Referring to FIGS. 1 and 2, the aerosol-generating device 1 may include at least one of a power supply 11, a controller 12, a sensor 13, or a heater 18. At least one of the power supply 11, the controller 12, the sensor 13, or the heater 18 may be disposed in a body 10 of the aerosol-generating device 1. The body 10 may define an insertion space 43 having an open top to allow a stick S, which is an aerosol-generating article, to be inserted thereinto. The insertion space 43 may be formed so as to be depressed to a predetermined depth toward the interior of the body 10 so that the stick S is inserted at least partway thereinto. The depth of the insertion space 43 may correspond to the length of the portion of the stick S that contains an aerosol-generating substance and/or medium. The lower end of the stick S may be inserted into the body 10, and the upper end of the stick S may protrude to the outside of the body 10. A user may inhale air by holding the upper end of the stick S, which is exposed to the outside, in the mouth.

The heater 18 may heat the stick S. The heater 18 may be elongated upward around a space into which the stick S is inserted. For example, the heater 18 may have a tubular shape including a hollow portion defined therein. The heater 18 may be disposed around the insertion space 43. The heater 18 may be disposed to surround at least a portion of the insertion space 43. The heater 18 may heat the insertion space 43 or the stick S inserted into the insertion space 43. The heater 18 may include an electro-resistive heater and/or an induction heater.

For example, referring to FIG. 1, the heater 18 may be a resistive heater. For example, the heater 18 may include an electrically conductive track and may be heated as current flows through the electrically conductive track. The heater 18 may be electrically connected to the power supply 11. The heater 18 may directly generate heat using current received from the power supply 11.

For example, referring to FIG. 2, the aerosol-generating device 1 may include an induction coil 181 surrounding the heater 18. The induction coil 181 may cause the heater 18 to generate heat. The heater 18 may generate heat using a magnetic field generated by alternating current flowing through the induction coil 181. The magnetic field may pass through the heater 18 to generate an eddy current in the heater 18. The eddy current may cause the heater 18 to generate heat.

Meanwhile, a susceptor may be included in the stick S. The susceptor in the stick S may generate heat using a magnetic field generated by alternating current flowing through the induction coil 181.

The power supply 11 may supply power so that components of the aerosol-generating device 1 operate. The power supply 11 may be referred to as a battery. The power supply 11 may supply power to at least one of the controller 12, the sensor 13, or the heater 18. If the aerosol-generating device 1 includes the induction coil 181, the power supply 11 may supply power to the induction coil 181.

The controller 12 may control overall operation of the aerosol-generating device 1. The controller 12 may be mounted on a printed circuit board. The controller 12 may control operation of at least one of the power supply 11 or the sensor 13. The controller 12 may control operation of a display, a motor, etc. mounted in the aerosol-generating device 1. The controller 12 may check the state of each of the components of the aerosol-generating device 1 and may determine whether the aerosol-generating device 1 is in an operable state.

The controller 12 may analyze a result of detection by the sensor 13 and may control subsequent processes. For example, the controller 12 may control, based on the result of detection by the sensor 13, power supplied to the heater 18 so that operation of the heater 18 commences or ends. For example, the controller 12 may control, based on the result of detection by the sensor 13, the amount of power supplied to the heater 18 and a power supply time so that the heater 18 is heated to a predetermined temperature or is maintained at an appropriate temperature.

The sensor 13 may include at least one of a temperature sensor, a puff sensor, or an insertion detection sensor. For example, the sensor 13 may detect at least one of the temperature of the heater 18, the temperature of the power supply 11, or the internal/external temperature of the body 10. For example, the sensor 13 may detect a user puff. For example, the sensor 13 may detect whether the stick S is inserted into the insertion space 43.

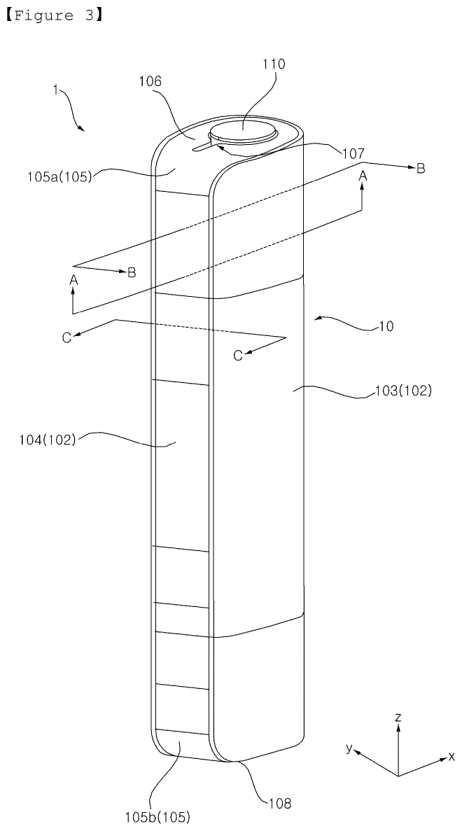

FIG. 3 is a front perspective view of an aerosol-generating device 1 according to an embodiment of the present disclosure.

Referring to FIG. 3, the body 10 may include a sidewall 102 formed to be elongated, a cover 106 defining one end, a base 108 defining the other end, and a door 110 configured to open and close the insertion space 43. The body 10 may have a cylindrical shape that is elongated in one direction.

The body 10 may include the sidewall 102 defining an outer side surface. The sidewall 102 may have a curved surface. The sidewall 102 may include a curved surface extending in the circumferential direction of the body 10.

The sidewall 102 may include a first sidewall 103. The first sidewall 103 may extend in the circumferential direction of the body 10. The first sidewall 103 may be bent in the circumferential direction of the body 10 and may have a space defined therein. One side of the first sidewall 103 may be open. The cross-sectional shape of the first sidewall 103 may be a loop having an open side.

The sidewall 102 may include a second sidewall 104. The second sidewall may 104 be elongated in the longitudinal direction of the body 10. The second sidewall 104 may be coupled to the first sidewall 103. The second sidewall 104 may be positioned between both ends of the first sidewall 103 in the circumferential direction and may define a surface that is continuous with the first sidewall 103. The second sidewall 104 may cover a side of the first sidewall 103 that is open in a lateral direction.

The body 10 may include the cover 106 defining one end in the longitudinal direction. The cover 106 may be coupled to one end of the first sidewall 103 in the longitudinal direction.

The body 10 may include a door 110. The door 110 may be coupled to the cover 106. The door 110 may open and close the insertion space 43 (see FIGS. 1 and 2) in a sliding manner. A rail 107 may be formed in the cover 106. The door 110 may slide along the rail 107.

The body 10 may include the base 108 defining the other end in the longitudinal direction. The base 108 may be coupled to the other end of the first sidewall 103 in the longitudinal direction.

The body 10 may include a first curved portion 105a interconnecting the cover 106 and the second sidewall 104. The first curved portion 105a may be curved to interconnect the cover 106 and the second sidewall 104.

The body 10 may include a second curved portion 105b interconnecting the base 108 and the second sidewall 104. The second curved portion 105b may be curved to interconnect the base 108 and the second sidewall 104.

A portion where the sidewall 102 and the cover 106 are connected may be formed in a rounded shape through the first curved portion 105a, and a portion where the sidewall 102 and the base 108 are connected may be formed in a rounded shape through the second curved portion 105b. Accordingly, resistance of the body 10 to external impact may be improved.

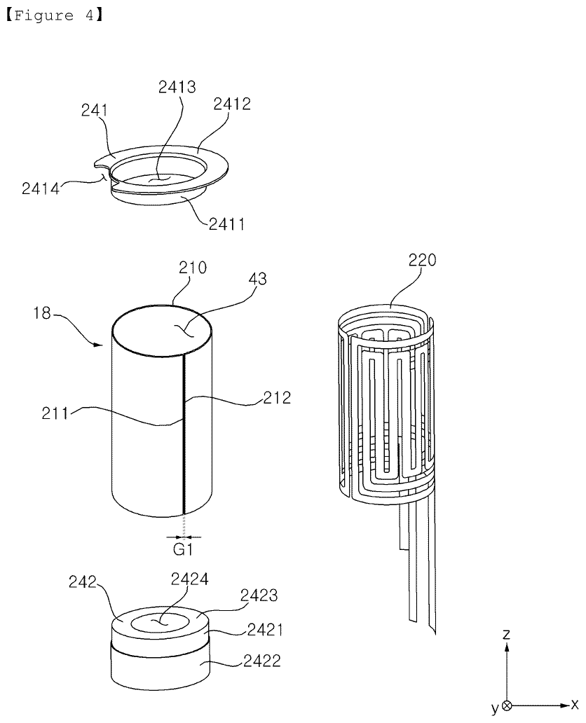

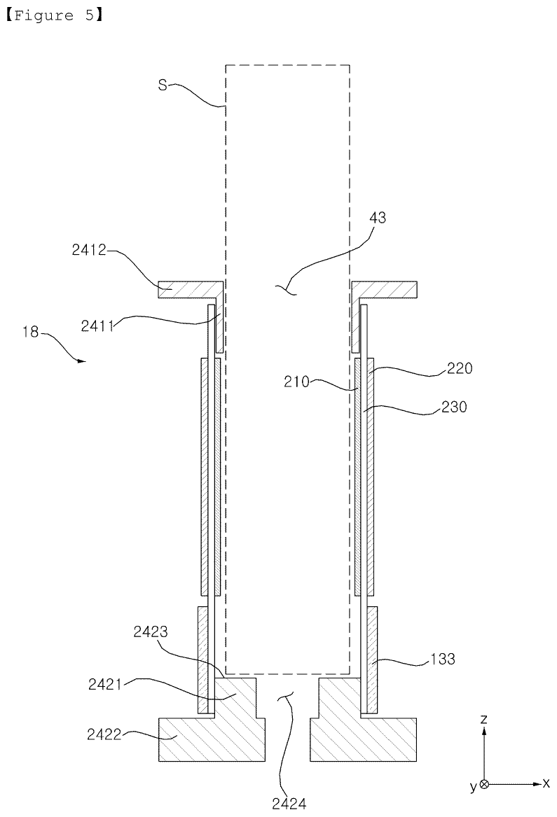

FIG. 4 is an exploded perspective view of a heater assembly 18 of the aerosol-generating device according to the embodiment of the present disclosure, and FIG. 5 is a cross-sectional view of the heater assembly 18 of the aerosol-generating device according to the embodiment of the present disclosure.

Referring to FIGS. 4 and 5, the heater 18 may be disposed in the body 10 (see FIGS. 1 to 3). The heater 18 may be referred to as a heater assembly. The heater assembly 18 may have a tubular shape or a cylindrical shape including a cavity formed therein. The heater assembly 18 may surround the insertion space 43. The heater assembly 18 may define the insertion space 43. The insertion space 43 or the stick S inserted into the insertion space 43 may be heated by the heater assembly 18.

The heater assembly 18 may include a susceptor 210, an electrically conductive track 220, and an insulator 230.

The susceptor 210 may have a cylindrical shape. The susceptor 210 may be disposed at the innermost portion of the hollow heater assembly 18. The susceptor 210 may be disposed inside the electrically conductive track 220. The susceptor 210 may surround at least a portion of the insertion space 43. At least a portion of the inner circumferential surface of the susceptor 210 may be in contact with the outer circumferential surface of the stick S inserted into the insertion space 43. The susceptor 210 may be referred to as a heat conductor, a heat conducting part, a heat diffusing part, or a pipe. The susceptor 210 may be made of steel, aluminum, or an alloy thereof without being limited thereto.

One end 211 of the susceptor 210 may be spaced apart from the other end 212 of the susceptor 210 in the circumferential direction of the susceptor 210 or the circumferential direction of the insertion space 43. A gap G1 may be defined between one end 211 and the other end 212 of the susceptor 210. The gap G1 may be elongated in the longitudinal direction of the insertion space 43. As the width of the gap G1 increases, the area of a portion of the stick S that is not heated due to the gap G1 may increase. Therefore, the gap G1 may correspond to an upper limit width at which an aerosol is generated from the stick S in a preset minimum required amount or more.

Accordingly, it may be possible to prevent a phenomenon that the shape of the susceptor 210 is distorted or parts of the susceptor 210 overlap each other in the process of manufacturing the susceptor 210 or the process in which the susceptor 210 is heated or cooled.

The electrically conductive track 220 may have a cylindrical shape. The electrically conductive track 220 may be disposed outside the susceptor 210. The electrically conductive track 220 may surround at least a portion of the susceptor 210. The electrically conductive track 220 may generate heat in response to power received from the power supply 11 (see FIGS. 1 and 2). The electrically conductive track 220 may be referred to as a heat-generating part. The electrically conductive track 220 may be formed by etching a thin metal film using a laser. The electrically conductive track 220 may be made of stainless steel, copper, aluminum, or alloys thereof without being limited thereto.

The insulator 230 may be disposed on one side of the electrically conductive track 220. The insulator 230 may be disposed inside and/or outside the electrically conductive track 220 and may have a cylindrical shape. The insulator 230 may cover the electrically conductive track 220. The insulator 230 may extend farther upward and downward than the electrically conductive track 220 in the longitudinal direction of the insertion space 43. The insulator 230 may be disposed between the susceptor 210 and the electrically conductive track 220 in the radial direction of the insertion space 43.

The insulator 230 may be formed of a flexible and heat-resistant material. The insulator 230 may include, but is not limited to, polyimide or polyetheretherketone (PEEK), and may include any other material having elasticity, heat resistance, and electrical insulation.

Brackets 241 and 242 may be coupled to the upper end and the lower end of the heater assembly 18. The brackets 241 and 242 may include a first bracket 241 attached or coupled to an upper side of the heater assembly 18 corresponding to the opening of the insertion space 43 and a second bracket 242 attached or coupled to a lower side of the heater assembly 18.

The first bracket 241 may include a first bracket body 2411, a first flange 2412, an insertion hole 2413, and an alignment recess 2414. The first bracket body 2411 may have a cylindrical shape. The first bracket body 2411 may be attached to or press-fitted into an upper end portion of the heater assembly 18. The first flange 2412 may protrude from an upper end of the first bracket body 2411 in the radially outward direction. The insertion hole 2413 may be formed vertically through the central portion of the first bracket 241. The alignment recess 2414 may be formed by one side of the first flange 2412 being recessed in the radially inward direction. The alignment recess 2414 may have a shape corresponding to a protrusion formed at the body 10. The alignment recess 2414 may be coupled to the protrusion formed at the body 10. Due to the alignment recess 2414, the heater assembly 18 may be prevented from rotating in the body 10 and may be stably coupled to the body 10.

The second bracket 242 may include a second bracket body 2421, a second flange 2422, and a hole 2424. The second bracket body 2421 may have a cylindrical shape. The second bracket body 2421 may be attached to or press-fitted into a lower end portion of the heater assembly 18. The second flange 2422 may protrude from a lower end of the second bracket body 2421 in the radially outward direction. The hole 2424 may be vertically formed through the central portion of the second bracket 242.

The insertion hole 2413 in the first bracket 241 may be in communication with an upper side of the insertion space 43. The hole 2424 in the second bracket 242 may be in communication with a lower side of the insertion space 43. The stick S may be inserted into the insertion space 43 through the insertion hole 2413. External air may flow into the stick S via an end portion of the stick S through the hole 2424 from the outside of the heater assembly 18. The inner circumferential surface of the first bracket body 2411 may support at least a portion of the outer circumferential surface of the stick S inserted into the insertion space 43. The upper surface 2423 of the second bracket body 2421 may support at least a portion of the lower end of the stick S inserted into the insertion space 43.

The brackets 241 and 242 may be made of stainless steel, aluminum, polyetheretherketone (PEEK), or alloys thereof without being limited thereto.

A stick detection sensor 133 may be disposed on the heater assembly 18. The stick detection sensor 133 may detect insertion and/or removal of the stick S. The stick detection sensor 133 may be disposed so as to surround at least a portion of the lower side of the heater assembly 18. The stick detection sensor 133 may be disposed below the susceptor 210 and the electrically conductive track 220 in the longitudinal direction of the insertion space 43. The stick detection sensor 133 may be disposed so as to be in contact with the portion of the insulator 230 that extends downward below the electrically conductive track 220 and to surround a portion of the periphery of the insulator 230. The stick detection sensor 133 may be spaced apart from the susceptor 210 and the electrically conductive track 220 in the longitudinal direction of the insertion space 43.

Accordingly, transfer of heat generated by the susceptor 210 and the electrically conductive track 220 to the stick detection sensor 133 may be minimized. In addition, the accuracy of detection of the stick S by the stick detection sensor 133 may be increased.

A stick recognition sensor (not shown) may be disposed on one side of the heater assembly 18. The stick recognition sensor may be disposed at a position corresponding to a region of the stick S inserted into the insertion space 43. The stick recognition sensor may detect a specific substance disposed in the region of the stick S. For example, the specific substance may be disposed in a wrapper corresponding to the region of the stick S. Through detection of the specific substance, the stick recognition sensor may detect at least one of a type of the stick S or authenticity of the stick S.

Although not shown in the drawings, a casing may be coupled to a side surface of the heater assembly 18. The casing may include a first casing surrounding a portion of the side surface of the heater assembly 18 and a second casing surrounding the remaining portion of the side surface of the heater assembly 18. The first casing and the second casing may be coupled to surround the side surface of the heater assembly 18 and may be combined with the brackets 241 and 242 coupled to the upper and lower ends of the heater assembly 18.

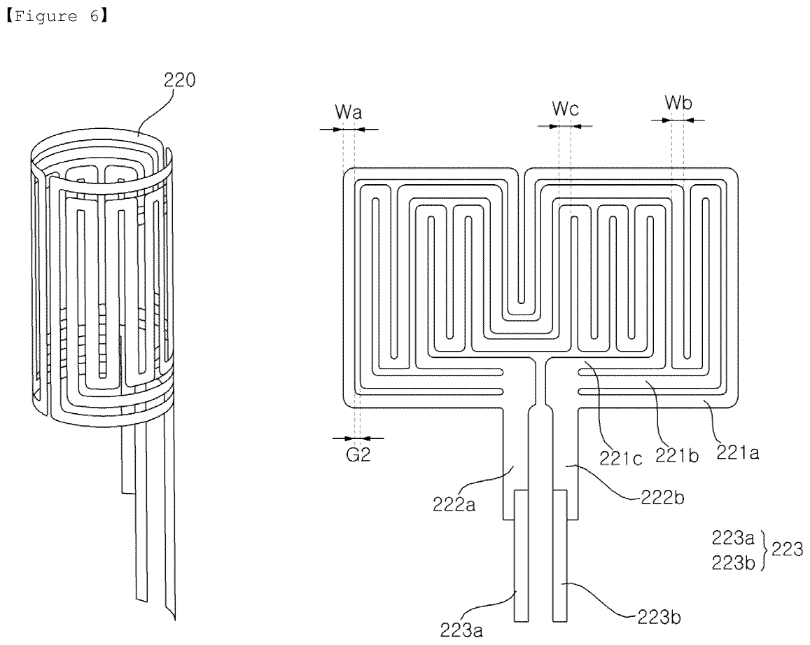

FIG. 6 is a view showing an electrically conductive track 220 of the heater assembly 18 according to the embodiment of the present disclosure.

Referring to FIG. 6, the electrically conductive track 220 may have a cylindrical shape. The electrically conductive track 220 may generate heat in response to power received from the power supply 11 (see FIGS. 1 and 2). Heat generated from the electrically conductive track 220 may heat a medium and/or a moisturizer in the stick S (see FIGS. 1 and 2) inserted into the insertion space 43 (see FIGS. 1 and 2), whereby an aerosol may be generated.

The electrically conductive track 220 may include a heat-generating track 221 and a connection portion 222. The heat-generating track 221 may include one or more tracks 221a, 221b, and 221c. The first track 221a may be disposed at the outermost portion of the electrically conductive track 220 and may have a rectangular shape overall. The second track 221b may be disposed inside the first track 221a. The third track 221c may be disposed inside the second track 221b.

Each of the first to third tracks 221a, 221b, and 221c may include at least one bent portion and may have a serpentine shape. The first to third tracks 221a, 221b, and 221c may be spaced apart from each other. One end of each of the first to third tracks 221a, 221b, and 221c may be connected to one end of each of the other tracks, and the other end of each of the first to third tracks 221a, 221b, and 221c may be connected to the other end of each of the other tracks. That is, the first to third tracks 221a, 221b, and 221c may be connected in parallel to each other.

The width Wa of the first track 221a may be less than or equal to the width Wb of the second track 221b. The width Wb of the second track 221b may be less than or equal to the width Wc of the third track 221c. The length of the first track 221a may be less than or equal to the length of the second track 221b. The length of the second track 221b may be less than or equal to the length of the third track 221c. A gap G2 by which the second track 221b is spaced apart from the first track 221a or the third track 221c may be less than the width Wa of the first track 221a, the width Wb of the second track 221b, and the width Wc of the third track 221c.

Accordingly, resistance deviation between the first track 221a disposed at the outermost portion of the electrically conductive track 220, the second track 221b disposed inside the first track 221a, and the third track 221c disposed inside the second track 221b may be reduced, and deviation between the amounts of heat generated from the respective tracks may be reduced.

In addition, because the gap between the tracks is less than the widths of the tracks, the heat-generating area of the electrically conductive track 220 may be increased, and the insertion space 43 or the stick S inserted into the insertion space 43 may be evenly heated by the electrically conductive track 220.

The connection portion 222 may protrude outward from one side of the heat-generating track 221. The connection portion 222 may be integrally formed with the heat-generating track 221. The connection portion 222 may be exposed from the insulator 230 covering the electrically conductive track 220. The connection portion 222 may include a first connection portion 222a and a second connection portion 222b. The first connection portion 222a may be connected to one end of each of the first to third tracks 221a, 221b, and 221c, and the second connection portion 222b may be connected to the other end of each of the first to third tracks 221a, 221b, and 221c.

A lead 223 may be connected to the electrically conductive track 220. The lead 223 may be connected to the connection portion 222. The lead 223 may be elongated in the direction in which the connection portion 222 protrudes. The lead 223 may electrically connect the electrically conductive track 220 to the power supply 11. The lead 223 may include a first lead 223a in contact with the first connection portion 222a and a second lead 223b in contact with the second connection portion 222b. Power may be supplied to the electrically conductive track 220 via the first lead 223a and the second lead 223b. The lead 223 may be attached to the connection portion 222 through welding. However, the disclosure is not limited to any specific method of attaching the lead 223 to the connection portion 222.

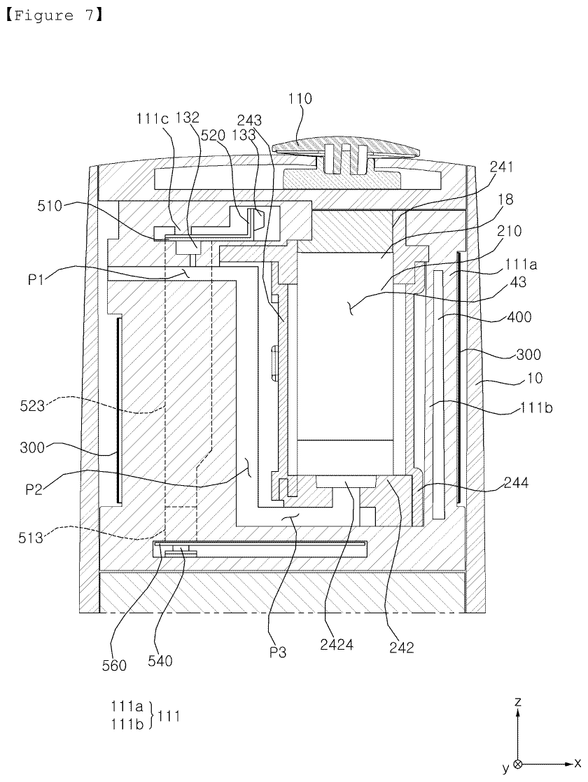

FIG. 7 is a cross-sectional view of an aerosol-generating device according to an embodiment of the present disclosure when viewed from the front. FIG. 7 shows a cross-section of the body 10 taken along line BB in FIG. 3.

Referring to FIG. 7, the aerosol-generating device 1 may include a body 10. The body 10 may have an insertion space 43 defined therein. The insertion space 43 may have an open side and may be elongated in the longitudinal direction of the body 10. The insertion space 43 may receive a stick S (see FIGS. 1, 2, and 5).

A body casing 111 may be disposed inside the body 10. The body casing 111 may support the body 10 inside the body 10. At least a portion of the body casing 111 may be coupled to or in contact with an inner surface of the body 10. The body casing 111 may accommodate a heater 18.

The body casing 111 may include a first body casing 111a and a second body casing 111b. The first body casing 111a may extend in the circumferential direction of the insertion space 43. The first body casing 111a may define an outer surface of the body casing 111. The second body casing 111b may be connected to the first body casing 111a and may be disposed inside the first body casing 111a. At least one space may be defined in the second body casing 111b. At least one space may be defined between the first body casing 111a and the second body casing 111b. The second body casing 111b may be integrally formed with the first body casing 111a.

The body casing 111 may include a support portion 111c. The support portion 111c may be positioned on one side of a heat spreader 520 and may protrude toward the heat spreader 520. The support portion 111c may be in contact with one side of the heat spreader 520 to support the heat spreader 520.

The heater 18 may surround the insertion space 43. The heater 18 may have a cylindrical shape having a hollow portion defined therein. At least portion of the insertion space 43 may be defined inside the heater 18. The heater 18 may extend in the longitudinal direction of the insertion space 43. The heater 18 may heat the insertion space 43 and/or the stick S received in the insertion space 43.

The heater 18 may be coupled to heater casings 243 and 244. The heater casings 243 and 244 may surround an outer side of the heater 18. The heater casings 243 and 244 may include a first heater casing 243 and a second heater casing 244. The first heater casing 243 may surround a portion of the side surface of the heater 18. The second heater casing 244 may surround the remaining portion of the side surface of the heater 18. The first heater casing 243 and the second heater casing 244 may be combined to surround the side surface of the heater 18. The first heater casing 243 and the second heater casing 244 may be coupled to the first bracket 241 (see FIGS. 4 and 5) and the second bracket 242 (see FIGS. 4 and 5), respectively.

The heater 18 and the heater casings 243 and 244 may be accommodated in the inner space in the second body casing 111b. The inner space in which the heater 18 and the heater casings 243 and 244 are accommodated may be referred to as a heater accommodating portion. The heater accommodating portion may have a substantially cylindrical shape. The heater accommodating portion may be elongated in the longitudinal direction of the insertion space 43.

An inflow passage P may be formed in the body casing 111. The inflow passage P may be formed in the second body casing 111b. The inflow passage P may be in communication with the outside of the body 10 and the insertion space 43. The inflow passage P may be in communication with the insertion space 43 through an inflow hole 2424.

The inflow passage P may include first to third passages P1, P2, and P3. The third passage P3 may be in communication with the insertion space 43. The third passage P3 may extend in a direction intersecting the longitudinal direction of the insertion space 43 in a region below the insertion space 43. The second passage P2 may be in communication with the third passage P3. The second passage P2 may extend from one end of the third passage P3 in the longitudinal direction of the insertion space 43. The second passage P2 may interconnect the third passage P3 and the first passage P1. The first passage P1 may be in communication with the second passage P2. The first passage P1 may extend from an upper end of the second passage P2 in a direction intersecting the longitudinal direction of the insertion space 43. The first passage P1 may be in communication with the outside of the body casing 111. External air of the aerosol-generating device 1 may be introduced into the body 10 through a gap formed in the body 10, may pass through the first to third passages P1, P2, and P3, and may flow into the insertion space 43 through the inflow hole 2424.

At least one sensor 132 or 133 may be provided in the body 10. The at least one sensor 132 or 133 may be disposed adjacent to the insertion space 43. The at least one sensor 132 or 133 may be connected to a circuit board 510. The at least one sensor 132 or 133 may be mounted on the circuit board 510 and may be electrically connected to the controller 12 through the circuit board 510.

The at least one sensor 132 or 133 may include a stick detection sensor 133 that detects a stick received in the insertion space 43 and a puff sensor 132 that is in communication with the insertion space 43. The stick detection sensor 133 and the puff sensor 132 may be disposed adjacent to each other.

The stick detection sensor 133 may be disposed adjacent to the insertion space 43. The stick detection sensor 133 may be disposed to face the insertion space 43. The stick detection sensor 133 may be disposed at a position corresponding to a region of the stick S inserted into the insertion space 43. The stick detection sensor 133 may detect whether the stick S is inserted into or removed from the insertion space 43. The stick detection sensor 133 may detect at least one of a type of the stick S or authenticity of the stick S.

The puff sensor 132 may be disposed on one side of the inflow passage P. The puff sensor 132 may output a signal corresponding to an internal pressure of the inflow passage P or a change in the internal pressure. The puff sensor 132 may output a signal corresponding to a user puff. The puff sensor 132 may be in communication with the inflow passage P and the insertion space 43. The puff sensor 132 may be disposed to face in direction intersecting the direction in which the stick detection sensor 133 faces. The puff sensor 132 may be disposed to face the inflow passage P.

The circuit 510 board may be connected to a connecting board 560. The at least one sensor 132 or 133 may be connected to one side of the circuit board 510, and a connector 540 may be connected to the opposite side of the circuit board 510. The connector 540 may be mounted on the circuit board 510. The circuit board 510 may be connected to the connecting board 560 through the connector 540. The controller 12 may be provided on the connecting board 560 or another board. The circuit board 510 may be connected to another board and/or the controller 12 provided in the body 10 through the connecting board 560.

At least a portion of the circuit board 510 may be in contact with the heat spreader 520. The heat spreader 520 may be disposed adjacent to the at least one sensor 132 or 133 disposed on the circuit board 510. The heat spreader 520 may be referred to as a sensor heat spreader. The heat spreader 520 may extend in a direction in which the circuit board 510 extends. For example, at least a portion of the circuit board 510 may extend in a direction away from the heater 18 (e.g., in a direction opposite the x-direction or in a direction opposite the z-direction), and at least a portion of the heat spreader 520 may extend in a direction away from the heater 18 together with the circuit board 510.

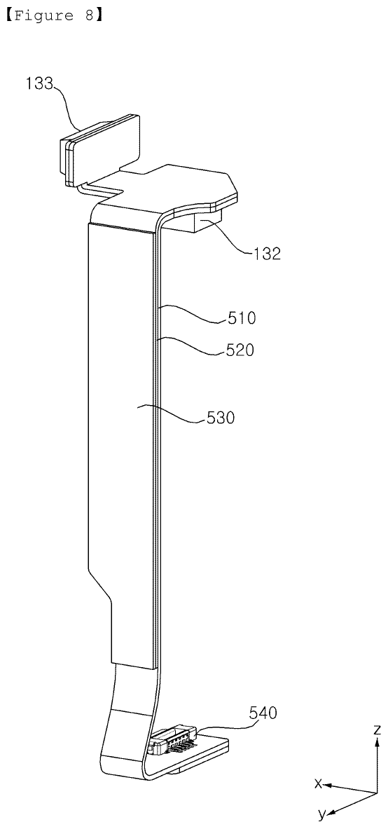

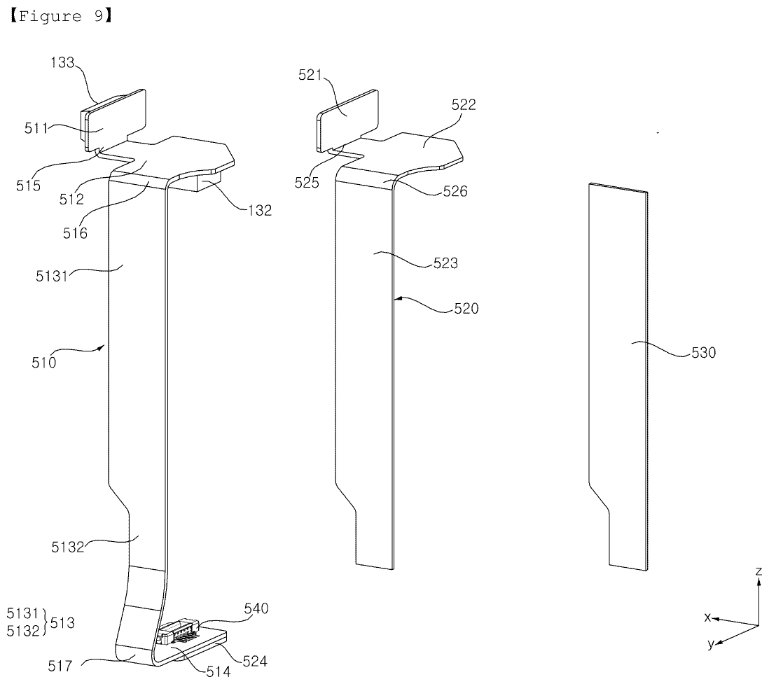

Concrete structures related to the circuit board 510 and the heat spreader 520 will now be described in detail with reference to FIGS. 8 and 9.

FIG. 8 is a perspective view showing a state in which the circuit board, the heat spreader, and a thermal interface material (TIM) are coupled in the aerosol-generating device according to the embodiment of the present disclosure, and FIG. 9 is a perspective view showing a state in which the circuit board, the heat spreader, and the TIM are separated in the aerosol-generating device according to the embodiment of the present disclosure.

Referring to FIGS. 8 and 9, the circuit board 510 may include a first board 511 to a fourth board 514.

The second board 512 may be connected to the first board 511 and may extend in a first direction (e.g., a direction opposite the x-direction). The third board 513 may be connected to the second board 512 and may extend in a second direction (e.g., a direction opposite the z-direction). The fourth board 514 may be connected to the third board 513 and may extend in a third direction (e.g., a direction opposite the y-direction). The first to fourth boards 511 to 514 may be integrally formed as a single continuous board.

The circuit board 510 may be at least partially bent. A first connection portion 515 may be disposed between the first board 511 and the second board 512 and may be bent in one direction. A second connection portion 516 may be disposed between the second board 512 and the third board 513 and may be bent in a direction intersecting the bent direction of the first connection portion 515. A third connection portion 517 may be disposed between the third board 513 and the fourth board 514 and may be bent in a direction intersecting the bent direction of the first connection portion 515. The circuit board 510 may include a flexible printed circuit board (FPCB). The circuit board 510 may include a polyimide film, but the material of the circuit board 510 is not limited thereto.

The first board 511 may be connected to the stick detection sensor 133. The stick detection sensor 133 may be mounted on one surface of the first board 511. The surface of the first board 511 on which the stick detection sensor 133 is mounted may face the insertion space 43. The second board 512 may be connected to the puff sensor 132. The puff sensor 132 may be mounted on one surface of the second board 512. The surface of the second board 512 on which the puff sensor 132 is mounted may face the inflow passage P. The direction in which the surface of the first board 511 on which the stick detection sensor 133 is mounted faces (e.g., the x-direction) and the direction in which the surface of the second board 512 on which the puff sensor 132 is mounted faces (e.g., a direction opposite the z-direction) may be different.

The stick detection sensor 133 and the puff sensor 132 may be disposed on the same surface of the circuit board 510 in the thickness direction of the circuit board 510. That is, the surface of the first board 511 on which the stick detection sensor 133 is mounted and the surface of the second board 512 on which the puff sensor 132 is mounted may form a single continuous surface through the first connection portion 515.

The third board 513 may be elongated in the second direction. The third board 513 may be referred to as an extending portion. The second direction may correspond to the longitudinal direction of the insertion space 43. The third board 513 may have a smaller width on a lower side than on an upper side. An upper portion 5131 of the third board 513 may extend from one end of the second board 512 or from the second connection portion 516 and may be elongated downward by a predetermined length while maintaining a predetermined width. A lower portion 5132 of the third board 513 may be connected to the upper portion 5131 and the fourth board 514, may have a smaller width than the upper portion 5131, and may be elongated downward.

The circuit board 510 may extend to a lower position than the heater 18 in the longitudinal direction of the insertion space 43 (see FIG. 7). For example, the upper portion 5131 of the third board 513 may extend to a lower position than the heater 18. For example, the lower portion 5132 of the third board 513 may be located at a lower position than the heater 18 in the longitudinal direction of the insertion space 43. That is, the third board 513 may be elongated downward by a predetermined length while maintaining a constant width, and a portion thereof that is located at a lower position than the heater 18 may have a reduced width.

The fourth board 514 may be connected to the connector 540. The connector 540 may be mounted on one surface of the fourth board 514. The connector 540 may be connected to the connecting board 560. The circuit board 510 may be connected to another board and/or the controller 12 provided in the body 10 through the connecting board 560.

The heat spreader 520 may include a first part 521 to a fourth part 524.

The second part 522 may be connected to the first part 521 and may extend in the first direction. The third part 523 may be connected to the second part 522 and may extend in the second direction. The first part 521 to the third part 523 may be integrally formed as a single continuous heat spreader. The fourth part 524 may be disposed to be spaced apart from the first part 521 to the third part 523.

The heat spreader 520 may be formed of a material having higher thermal conductivity than that of the circuit board 510. For example, the heat spreader 520 may include at least one of graphite, copper, gold, silver, nanocrystals, or aluminum.

The heat spreader 520 may be in contact with at least a portion of the circuit board 510. For example, the first part 521 may be in contact with the first board 511. The second part 522 may be in contact with the second board 512. The third part 523 may be in contact with the third board 513. The fourth part 524 may be in contact with the fourth board 514.

The heat spreader 520 may cover at least a portion of the circuit board 510. For example, the first part 521 may be in contact with the opposite surface of the first board 511 and may cover at least a portion of the opposite surface. The second part 522 may be in contact with the opposite surface of the second board 512 and may cover at least a portion of the opposite surface. The third part 523 may be in contact with one surface of the third board 513 and may cover at least a portion of the surface. The fourth part 524 may be in contact with one surface of the fourth board 514 and may cover at least a portion of the surface.

The heat spreader 520 may have a shape corresponding to at least a portion of the circuit board 510. For example, the first part 521 may have a shape corresponding to the first board 511. The second part 522 may have a shape corresponding to the second board 512. The third part 523 may have a shape corresponding to at least portion of the third board 513. The fourth part 524 may have a shape corresponding to at least a portion of the fourth board 514.

The heat spreader 520 may be in contact with surface of the circuit board 510 opposite the surface on which the stick detection sensor 133 and the puff sensor 132 are disposed. For example, the first part 521 may be in contact with a surface of the first board 511 opposite the surface on which the stick detection sensor 133 is mounted. The second part 522 may be in contact with a surface of the second board 512 opposite the surface on which the puff sensor 132 is mounted.

In this way, because the heat spreader 520 is disposed in contact with a surface of the circuit board 510 opposite the surface on which the sensors 132 and 133 are disposed, the structure of the heat spreader 520 may be simplified.

At least a portion of the heat spreader 520 may be bent. A first bent portion 525 may be disposed between the first part 521 and the second part 522 and may be bent in one direction. A second bent portion 526 may be disposed between the second part 522 and the third part 523 and may be bent in a direction intersecting the direction in which the first bent portion 525 is bent.

The heat spreader 520 may be bent in a shape corresponding to the bent shape of the circuit board 510. For example, the first bent portion 525 may be bent in a shape corresponding to the bent shape of the first connection portion 515. The second bent portion 526 may be bent in a shape corresponding to the bent shape of the second connection portion 516.

In this way, because the heat spreader 520 has a bent shape corresponding to the bent shape of the circuit board 510, a contact area between the heat spreader 520 and the circuit board 510 may increase. Accordingly, heat may be effectively transferred from the sensors 132 and 133 to the heat spreader 520.

In addition, because the fourth part 524 that is in contact with the fourth board 514 on which the connector 540 is mounted is spaced apart from the first to third parts 521, 522, and 523, rather than being connected thereto, it may be possible to prevent the heat spreader 520 from being deformed or damaged during a process of connecting the connector 540 to the connecting board 560.

The heat spreader 520 may extend to a lower position than the heater 18 in the longitudinal direction of the insertion space 43 (see FIG. 7). For example, the third part 523 may extend to a lower position than the heater 18. The third part 523 may have a shape corresponding to at least part of the upper portion 5131 and the lower portion 5132 of the third board 513. The third part 523 may be elongated downward by a predetermined length while maintaining a constant width, and a portion thereof that is located at a lower position than the heater 18 may have a reduced width.

In this way, because the heat spreader 520 extends to a lower position than the heater 18, heat generated by the heater 18 and transferred to the sensors 132 and 133 may be delivered or emitted in a direction away from the heater 18 and the sensors 132 and 133.

A thermal interface material (TIM) 530 may be in contact with the heat spreader 520. The TIM 530 may extend in the extending direction of the heat spreader 520. The TIM 530 may have a shape corresponding to at least a portion of the heat spreader 520. For example, the TIM 530 may have a shape corresponding to the third part 523 of the heat spreader 520 and may cover one side of the third part 523. One surface of the third part 523 may be in contact with one surface of the third board 513 of the circuit board 510, and the opposite surface of the third part 523 may be in contact with one surface of the TIM 530. The TIM 530 may include a thermal paste or a sealer. One surface of the TIM 530 may be in contact with the heat spreader 520, and the opposite surface thereof may be in contact with at least a portion of the body casing 111.

In this way, because the TIM 530 is disposed between the heat spreader 520 and the body casing 111 and is in contact with the heat spreader 520 and the body casing 111, heat emitted from the heat spreader 520 may be effectively transferred to other structures in the device.

Meanwhile, the TIM 530 is not necessarily required. The heat spreader 520 may be in direct contact with the body casing 111 to transfer heat to other structures in the device.

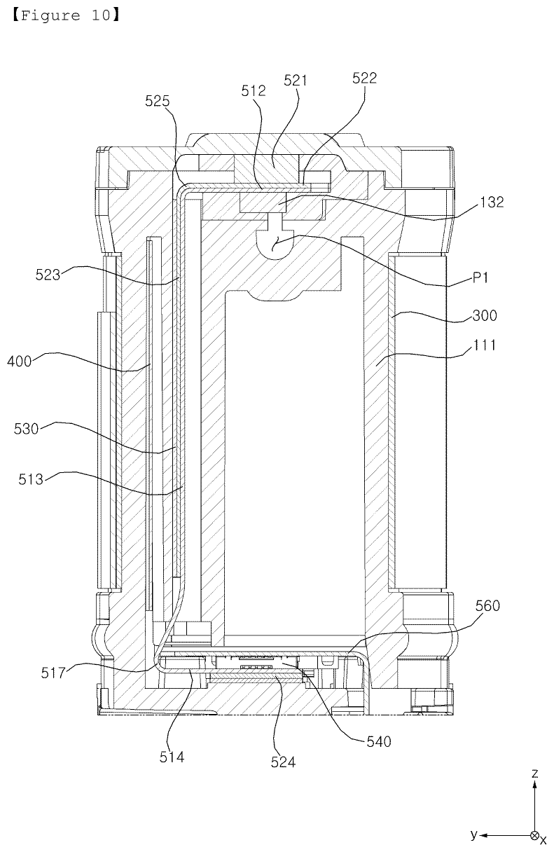

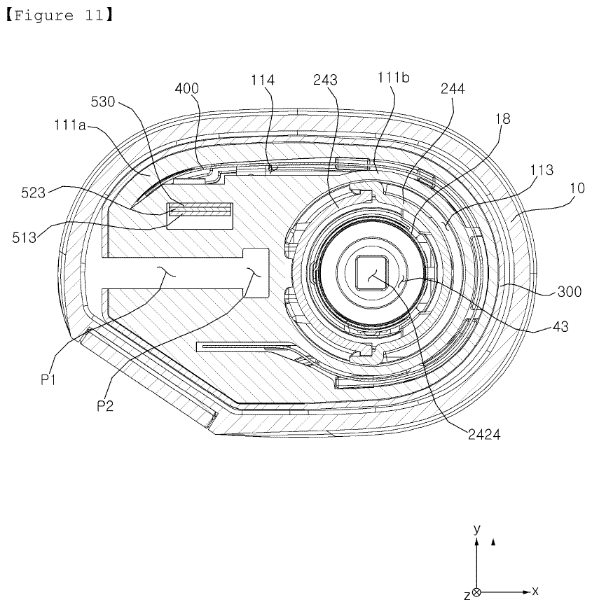

FIG. 10 is a cross-sectional view of the aerosol-generating device according to the embodiment of the present disclosure when viewed from side, and FIG. 11 is a cross-sectional view of the aerosol-generating device according to the embodiment of the present disclosure when viewed from above. FIG. 10 shows a cross-section of the body 10 taken along line CC in FIG. 3, and FIG. 11 shows a cross-section of the body 10 taken along line AA in FIG. 3. Illustration of the body 10 is omitted in FIG. 10.

Referring to FIG. 10 together with FIG. 7, the heat spreader 520 may be disposed adjacent to the inflow passage P. For example, the first part 521 and the second part 522 of the heat spreader 520 may be disposed above the first passage P1 and may be disposed adjacent to the first passage P1. For example, the third part 523 of the heat spreader 520 may be disposed on one side of each of the first passage P1 and the second passage P2 and may be disposed adjacent to the first passage P1 and the second passage P2. The direction in which the third part 523 extends may correspond to the direction in which the second passage P2 extends.

While the user inhales an aerosol using the aerosol-generating device 1, the temperature of air flowing through the first passage P1, into which external air is introduced, may be lower than the temperature of air flowing through the second passage P2 and the third passage P3. In the heat spreader 520, the first part 521 and the second part 522, which are disposed adjacent to the sensors 132 and 133, may receive more heat than the third part 523 and the fourth part 524.

Because the first part 521 and the second part 522 are disposed adjacent to the first passage P1, through which air having the lowest temperature flows, the heat spreader 520 may be effectively cooled.

In addition, because the third part 523 extends in the extending direction of the second passage P2, the heat spreader 520 may be effectively cooled.

While the user operates the aerosol-generating device 1 without inhaling an aerosol, a portion of the air heated by the heater 18 may flow into the inflow passage P through the inflow hole 2424. In this case, the temperature of air flowing through the first passage P1, which is spaced farthest from the inflow hole 2424, may be lower than the temperature of air flowing through the second passage P2 and the third passage P3.

Because the first part 521 and the second part 522 are disposed adjacent to the first passage P1, through which air having the lowest temperature flows, the influence of the heated air within the inflow passage P may be minimized.

Referring to FIG. 11 together with FIG. 10, at least one heat sink 300 or 400 may be disposed inside the body 10. The heat sink 300 or 400 may be referred to as a body heat sink or a heater heat sink. A first heat sink 300 may be disposed outside the heat spreader 520 and outside the heater 18 in the radial direction of the insertion space 43. The first heat sink 300 may surround at least a portion of the outer sides of the heat spreader 520 and the heater 18. The first heat sink 300 may be disposed to be spaced apart from the heat spreader 520 and the heater 18 in the radial direction of the insertion space 43. The first heat sink 300 may have a shape corresponding to the inner surface of the body 10. The first heat sink 300 may be disposed to face the inner surface of the body 10.

A second heat sink 400 may be disposed inside the body casing 111. The second heat sink 400 may be disposed in a space 114 defined between the first body casing 111a and the second body casing 111b. The space 114 may be referred to as a heat sink accommodation portion. The heat sink accommodation portion 114 may be defined between the inner surface of the first body casing 111a and the outer surface of the second body casing 111b. The heat sink accommodation portion 114 may be defined along the inner circumferential surface of the first body casing 111a. The heat sink accommodation portion 114 may extend in the longitudinal direction of the insertion space 43.

The second heat sink 400 may be disposed outside the second body casing 111b. The second heat sink 400 may surround at least a portion of the second body casing 111b in the circumferential direction of the insertion space 43. The second heat sink 400 may be disposed outside the heat spreader 520 and outside the heater 18 in the radial direction of the insertion space 43. The second heat sink 400 may surround at least a portion of the outer sides of the heat spreader 520 and the heater 18. The second heat sink 400 may be disposed to be spaced apart from the heat spreader 520 and the heater 18 in the radial direction of the insertion space 43. At least a portion of the second heat sink 400 may be disposed to be spaced apart from the outer wall and inner wall of the heat sink accommodation portion 114 in the radial direction of the insertion space 43. A gap may be defined between the inner surface of the second heat sink 400 and the inner wall of the heat sink accommodation portion 114 and/or between the outer surface of the second heat sink 400 and the outer wall of the heat sink accommodation portion 114. The second heat sink 400 may be disposed inside the first heat sink 300 in the radial direction of the insertion space 43.

At least a portion of the heat spreader 520 may be in contact with one side of the body casing 111. For example, the third part 523 of the heat spreader 520 may be in contact with one side of the second body casing 111b. The third part 523 of the heat spreader 520 may be disposed in a space defined in the second body casing 111b and may be in contact with a surface adjacent to the region in which the first and second heat sinks 300 and 400 are disposed.

Meanwhile, if the TIM 530 is provided, one surface of the TIM 530 may be in contact with the heat spreader 520, and the opposite surface thereof may be in contact with at least a portion of the body casing 111. The opposite surface of the TIM 530 may be in contact with a surface adjacent to the region in which the first and second heat sinks 300 and 400 are disposed.

In this way, because at least one heat sink 300 or 400 is disposed outside the heat spreader 520, heat emitted from the heat spreader 520 may be effectively transferred to the outside of the device.

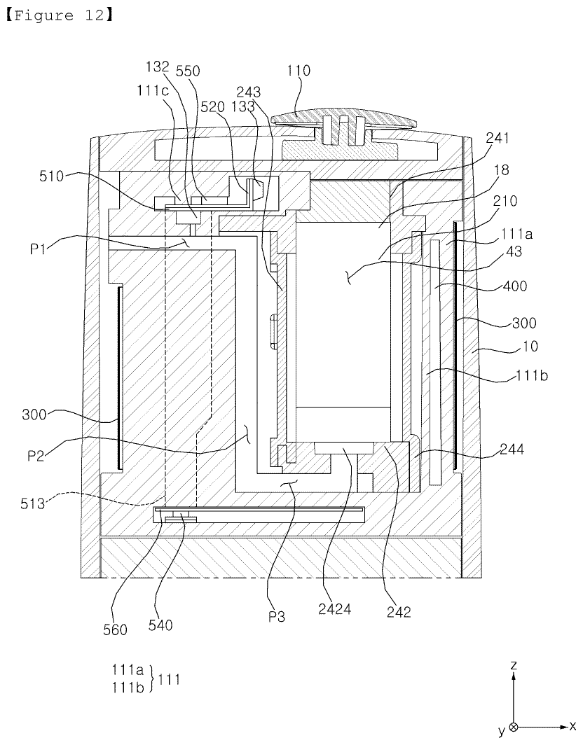

FIG. 12 is a cross-sectional view of an aerosol-generating device according to another embodiment of the present disclosure when viewed from the front. FIG. 12 shows a cross-section of the body 10 taken along line BB in FIG. 3. Detailed descriptions of the features in FIG. 12 that are identical to those described with reference to FIGS. 7 to 11 will be omitted.

Referring to FIG. 12, at least a portion of the circuit board 510 may be in contact with the heat spreader 520. The heat spreader 520 may be disposed adjacent to at least one sensor 132 or 133 disposed on the circuit board 510. The heat spreader 520 may extend in the extending direction of the circuit board 510. For example, at least a portion of the circuit board 510 may extend in a direction away from the heater 18 (e.g., a direction opposite the x-direction), and at least a portion of the heat spreader 520 may extend in a direction away from the heater 18 together with the circuit board 510.

The body casing 111 may include a support portion 111c. The support portion 111c may be positioned on one side of the heat spreader 520 and may protrude toward the heat spreader 520. The support portion 111c may be in contact with one side of the heat spreader 520. For example, the support portion 111c may protrude downward toward the second part 522 of the heat spreader 520 and may be in contact with the upper side of the second part 522 to support the second part 522.

A TIM 550 may be disposed on one side of the heat spreader 520. One surface of the TIM 550 may be in contact with the heat spreader 520, and the opposite surface thereof may be in contact with the body casing 111. For example, the TIM 550 may be disposed on an upper side of the second part 522 of the heat spreader 520 such that one surface thereof is in contact with the upper surface of the second part 522 and the opposite surface thereof is in contact with the body casing 111.

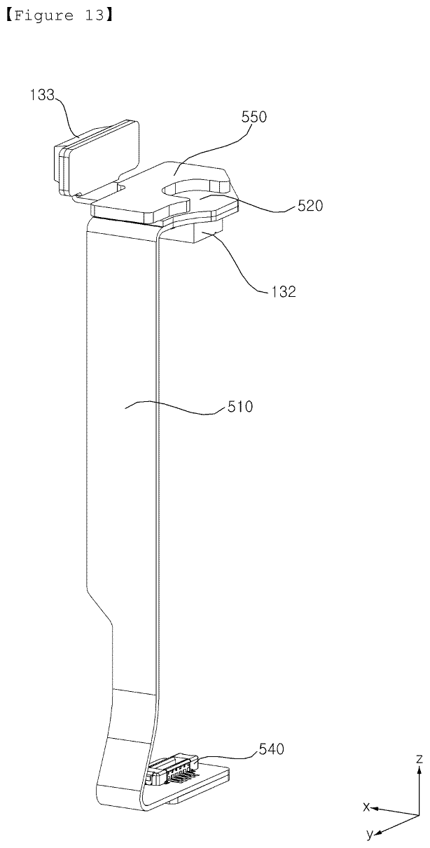

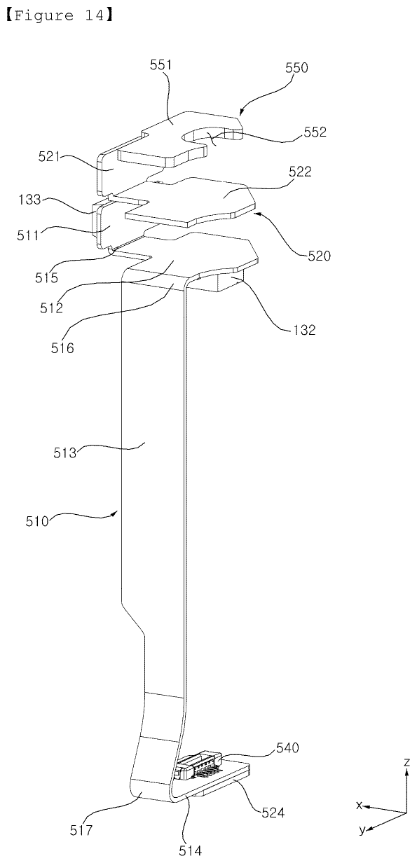

FIG. 13 is a perspective view showing a state in which the circuit board, the heat spreader, and the TIM are coupled in the aerosol-generating device according to the other embodiment of the present disclosure, and FIG. 14 is a perspective view showing a state in which the circuit board, the heat spreader, and the TIM are separated in the aerosol-generating device according to the other embodiment of the present disclosure. Detailed descriptions of the features in FIGS. 13 and 14 that are identical to those described with reference to FIGS. 7 to 11 will be omitted.

Referring to FIGS. 13 and 14, the circuit board 510 may include a first board 511 to a fourth board 514.

At least a portion of the circuit board 510 may be bent. A first connection portion 515 may be disposed between the first board 511 and the second board 512 and may be bent in one direction. A second connection portion 516 may be disposed between the second board 512 and the third board 513 and may be bent in a direction intersecting the bent direction of the first connection portion 515. A third connection portion 517 may be disposed between the third board 513 and the fourth board 514 and may be bent in a direction intersecting the bent direction of the first connection portion 515.

The first board 511 may be connected to the stick detection sensor 133. The stick detection sensor 133 may be mounted on one surface of the first board 511. The surface of the first board 511 on which the stick detection sensor 133 is mounted may face the insertion space 43. The second board 512 may be connected to the puff sensor 132. The puff sensor 132 may be mounted on one surface of the second board 512. The surface of the second board 512 on which the puff sensor 132 is mounted may face the inflow passage P. The direction in which the surface of the first board 511 on which the stick detection sensor 133 is mounted faces (e.g., the x-direction) and the direction in which the surface of the second board 512 on which the puff sensor 132 is mounted faces (e.g., a direction opposite the z-direction) may be different.

The stick detection sensor 133 and the puff sensor 132 may be disposed on the same surface of the circuit board 510 in the thickness direction of the circuit board 510. That is, the surface of the first board 511 on which the stick detection sensor 133 is mounted and the surface of the second board 512 on which the puff sensor 132 is mounted may form a single continuous surface through the first connection portion 515.

The heat spreader 520 may include a first part 521, a second part 522, and a fourth part 524.

The first part 521 may be in contact with the first board 511. The second part 522 may be connected to the first part 521 and may extend in a first direction in which the second board 512 extends. The second part 522 may be in contact with the second board 512. The first part 521 and the second part 522 may be integrally formed as a single continuous heat spreader. The fourth part 524 may be disposed to be spaced apart from the first part 521 and the second part 522. The fourth part 524 may be in contact with the fourth board 514.

The heat spreader 520 may have a shape corresponding to at least a portion of the circuit board 510. For example, the first part 521 may have a shape corresponding to the first board 511. The second part 522 may have a shape corresponding to the second board 512. The fourth part 524 may have a shape corresponding to at least a portion of the fourth board 514.

The heat spreader 520 may be in contact with a surface of the circuit board 510 opposite the surface on which the stick detection sensor 133 and the puff sensor 132 are disposed. For example, the first part 521 may be in contact with a surface of the first board 511 opposite the surface on which the stick detection sensor 133 is mounted. The second part 522 may be in contact with a surface of the second board 512 opposite the surface on which the puff sensor 132 is mounted.

The heat spreader 520 may be bent in a shape corresponding to the bent shape of the circuit board 510. For example, the first bent portion 525 may be bent in a shape corresponding to the bent shape of the first connection portion 515.

The TIM 550 may be disposed on one side of the heat spreader 520. The TIM 550 may be disposed on an upper side of the second part 522 of the heat spreader 520 such that one surface thereof is in contact with the upper surface of the second part 522 and the opposite surface thereof is in contact with the body casing 111.

The TIM 550 may include a recess 552. The recess 552 may be formed by one side of the TIM 550 being recessed. The recess 552 may surround at least part of the support portion 111c. The support portion 111c may pass through the recess 552 and may be in contact with a portion of the heat spreader 520 that is exposed below the recess 552, thereby supporting the heat spreader 520.

Accordingly, the heat spreader 520 may be firmly supported within the body casing 111, and heat emitted from the heat spreader 520 may be effectively transferred to other structures in the device through the TIM 550.

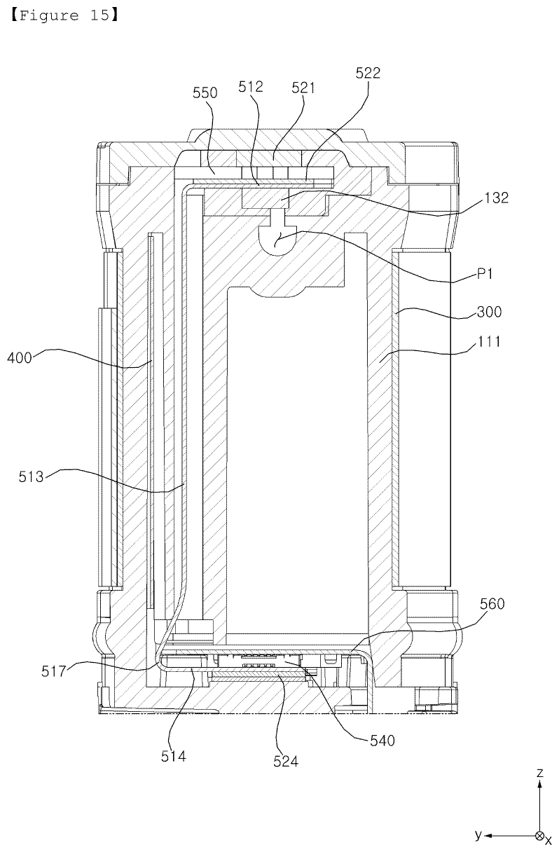

FIG. 15 is a cross-sectional view of the aerosol-generating device according to the other embodiment of the present disclosure when viewed from side. FIG. 15 shows a cross-section of the body 10 taken along line CC in FIG. 3. Illustration of the body y 10 is omitted in FIG. 15. Detailed descriptions of the features in FIG. 15 that are identical to those described with reference to FIGS. 7 to 11 will be omitted.

Referring to FIG. 15 together with FIG. 12, the heat spreader 520 may be disposed adjacent to the inflow passage P. For example, the first part 521 and the second part 522 of the heat spreader 520 may be disposed above the first passage P1 and may be disposed adjacent to the first passage P1.

While the user inhales an aerosol using the aerosol-generating device 1, the temperature of air flowing through the first passage P1, into which external air is introduced, may be lower than the temperature of air flowing through the second passage P2 and the third passage P3.

Because the first part 521 and the second part 522 are disposed adjacent to the first passage P1, through which air having the lowest temperature flows, the heat spreader 520 may be effectively cooled.

While the user operates the aerosol-generating device 1 without inhaling an aerosol, a portion of the air heated by the heater 18 may flow into the inflow passage P through the inflow hole 2424. In this case, the temperature of air flowing through the first passage P1, which is spaced farthest from the inflow hole 2424, may be lower than the temperature of air flowing through the second passage P2 and the third passage P3.

Because the first part 521 and the second part 522 are disposed adjacent to the first passage P1, through which air having the lowest temperature flows, the influence of the heated air within the inflow passage P may be minimized.

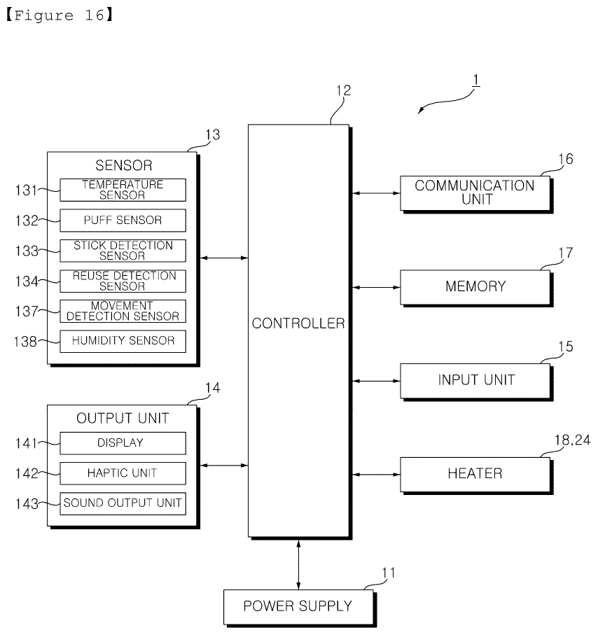

FIG. 16 is a block diagram of an aerosol-generating device 1 according to an embodiment of the present disclosure.

The aerosol-generating device 1 may include a power supply 11, a controller 12, a sensor 13, an output unit 14, an input unit 15, a communication unit 16, a memory 17, and one or more heaters 18 and 24. However, the internal structure of the aerosol-generating device 1 is not limited to that shown in FIG. 16. That is, it is to be understood by those skilled in the art that some of the components shown in FIG. 16 may be omitted or new components may be added depending on the design of the aerosol-generating device 1.

The sensor 13 may detect the state of the aerosol-generating device 1 or the state of the surrounding of the aerosol-generating device 1 and may transmit information about the detected state to the controller 12. Based on the information about the detected state, the controller 12 may control the aerosol-generating device 1 to perform various functions, such as control of operation of the cartridge heater 24 and/or the heater 18, smoking restriction, determination as to whether the stick S and/or the cartridge 19 is inserted, and notification display.

The sensor 13 may include at least one of a temperature sensor 131, a puff sensor 132, an insertion detection sensor 133, a reuse detection sensor 134, a movement detection sensor 137, or a humidity sensor 138.

The temperature sensor 131 may detect temperature to which the cartridge heater 24 and/or the heater 18 is heated. The aerosol-generating device 1 may include a separate temperature sensor configured to detect the temperature of the cartridge heater 24 and/or the heater 18, or the cartridge heater 24 and/or the heater 18 itself may serve as a temperature sensor.

The temperature sensor 131 may output a signal corresponding to the temperature of the cartridge heater 24 and/or the heater 18. For example, the temperature sensor 131 may include a resistive element that changes in resistance value according to a change in temperature of the cartridge heater 24 and/or the heater 18. The temperature sensor may be implemented as a thermistor, which is an element characterized in that the resistance thereof changes with temperature. In this case, the temperature sensor 131 may output a signal corresponding to the resistance value of the resistive element as a signal corresponding to the temperature of the cartridge heater 24 and/or the heater 18. For example, the temperature sensor 131 may be configured as a sensor configured to detect the resistance value of the cartridge heater 24 and/or the heater 18. In this case, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be disposed around the power supply 11 to monitor the temperature of the power supply 11. The temperature sensor 131 may be disposed adjacent to the power supply 11. For example, the temperature sensor 131 may be attached to one surface of the battery, which is the power supply 11. For example, the temperature sensor 131 may be mounted on one surface of a printed circuit board.

The temperature sensor 131 may be disposed in the body 10 to detect the internal temperature of the body 10.

The puff sensor 132 may detect a user puff based on various physical changes in a gasflow path. The puff sensor 132 may output a signal corresponding to a puff. For example, the puff sensor 132 may be a pressure sensor. The puff sensor 132 may output a signal corresponding to the internal pressure of the aerosol-generating device. Here, the internal pressure of the aerosol-generating device 1 may correspond to the pressure of the gasflow path through which gas flows. The puff sensor 132 may be disposed at a position corresponding to the gasflow path through which gas flows in the aerosol-generating device 1.

The stick detection sensor 133 may detect insertion and/or removal of the stick S. The stick detection sensor may be referred to as an insertion detection sensor. The insertion detection sensor 133 may detect a signal change caused by insertion and/or removal of the stick S. The insertion detection sensor 133 may be mounted around the insertion space. The insertion detection sensor 133 may detect insertion and/or removal of the stick S according to a change in dielectric constant in the insertion space. For example, the insertion detection sensor 133 may be an inductive sensor and/or a capacitance sensor.

The inductive sensor may include at least one coil. The coil of the inductive sensor may be disposed adjacent to the insertion space. For example, if a magnetic field changes around a coil through which current flows, the characteristics of the current flowing through the coil may change according to Faraday's law of electromagnetic induction. Here, the characteristics of the current flowing through the coil may include a frequency of alternating current, a current value, a voltage value, an inductance value, an impedance value, and the like.

The inductive sensor may output a signal corresponding to the characteristics of the current flowing through the coil. For example, the inductive sensor may output a signal corresponding to the inductance value of the coil.

The capacitance sensor may include a conductive body. The conductive body of the capacitance sensor may be disposed adjacent to the insertion space. The capacitance sensor may output a signal corresponding to the electromagnetic characteristics of the surroundings, for example, the capacitance around the conductive body. For example, if the stick S including a metallic wrapper is inserted into the insertion space, the electromagnetic characteristics around the conductive body may change due to the wrapper of the stick S.

The reuse detection sensor 134 may detect whether the stick S is being reused. The reuse detection sensor 134 may be a color sensor. The color sensor may detect the color of the stick S. The color sensor may detect the color of a portion of the wrapper surrounding the outer side of the stick S. The color sensor may detect, based on light reflected from an object, a value for the optical characteristic corresponding to the color of the object. For example, the optical characteristic may be the wavelength of light. The color sensor may be implemented as a component integrated with a proximity sensor or may be implemented as a component provided separately from a proximity sensor.

At least a portion of the wrapper constituting the stick S may change in color due to an aerosol. The reuse detection sensor 134 may be disposed at a position corresponding to a position at which at least a portion of the wrapper, which changes in color due to an aerosol, is disposed when the stick S is inserted into the insertion space. For example, before the stick S is used by the user, the color of at least a portion of the wrapper may be a first color. In this case, while the aerosol generated by the aerosol-generating device 1 passes through the stick S, at least a portion of the wrapper may become wet due to the aerosol, and accordingly, the color of at least a portion of the wrapper may change to a second color. After changing from the first color to the second color, the color of at least a portion of the wrapper may be maintained in the second color.

The movement detection sensor 137 may detect movement of the aerosol-generating device. The movement detection sensor 137 may be implemented as at least one of an acceleration sensor or a gyro sensor.

The humidity sensor 138 may detect the humidity of the aerosol-generating device and/or the cartridge. The humidity sensor 138 may detect the humidity of outside air and/or the humidity in the cartridge. The humidity sensor 138 may be implemented as a capacitive sensor or the like. The humidity sensor 138 may be disposed on the outer side of the body 10 or may be located in a path through which outside air is introduced to measure the humidity of the surroundings of the aerosol-generating device 1. The humidity sensor 138 may be located in the storage portion CO of the cartridge 19 to measure the humidity in the cartridge 19.

In addition to the sensors 131 to 138 described above, the sensor 13 may further include at least one of a barometric pressure sensor, a magnetic sensor, a position sensor (GPS), or a proximity sensor. The functions of the sensors could be intuitively deduced by those skilled in the art from the names thereof, and thus detailed descriptions thereof will be omitted.

The output unit 14 may output information about the state of the aerosol-generating device 1 and may provide the information to the user. The output unit 14 may include at least one of a display 141, a haptic unit 142, or a sound output unit 143. However, the disclosure is not limited thereto. If the display 141 and a touchpad form a touchscreen together in a layered structure, the display 141 may be used as not only an output device but also an input device.

The display 141 may visually provide information about the aerosol-generating device 1 to the user. For example, the information about the aerosol-generating device 1 may include various pieces of information, such as a charging/discharging state of the power supply 11 of the aerosol-generating device 1, a preheating state of the heater 18, an insertion/removal state of the stick S and/or the cartridge 19, a mounting/removal state of the upper case, and a use restriction state of the aerosol-generating device 1 (e.g., detection of an abnormal article), and the display 141 may output the information to the outside. For example, the display 141 may be in the form of a light-emitting diode (LED) device. For example, the display 141 may be a liquid crystal display panel (LCD), an organic light-emitting display panel (OLED), or the like.

The haptic unit 142 may convert an electrical signal into mechanical stimulation or electrical stimulation to haptically provide the information about the aerosol-generating device 1 to the user. For example, if initial power is supplied to the cartridge heater 24 and/or the heater 18 for a predetermined amount of time, the haptic unit 142 may generate vibration corresponding to completion of initial preheating. The haptic unit 142 may include a vibration motor, a piezoelectric element, or an electrical stimulation device.

The sound output unit 143 may audibly provide information about the aerosol-generating device 1 to the user. For example, the sound output unit 143 may convert an electrical signal into an acoustic signal and may output the acoustic signal to the outside.

The power supply 11 may supply power used for operation of the aerosol-generating device 1. The power supply 11 may supply power so that the cartridge heater 24 and/or the heater 18 is heated. In addition, the power supply 11 may supply power necessary for operation of the other components provided in the aerosol-generating device 1, such as the sensor 13, the output unit 14, the input unit 15, the communication unit 16, and the memory 17. The power supply 11 may be a rechargeable battery ora disposable battery. For example, the power supply 11 may be a lithium polymer (LiPoly) battery. However, the disclosure is not limited thereto.

Although not shown in FIG. 16, the aerosol-generating device 1 may further include a power supply protection circuit. The power supply protection circuit may be electrically connected to the power supply 11 and may include a switching element.

The power supply protection circuit may block an electric path to the power supply 11 according to a predetermined condition. For example, the power supply protection circuit may block the electric path to the power supply 11 when the voltage level of the power supply 11 is equal to or higher than a first voltage corresponding to overcharge. For example, the power supply protection circuit may block the electric path to the power supply 11 when the voltage level of the power supply 11 is lower than a second voltage corresponding to overdischarge.

The heater 18 may receive power from the power supply 11 to heat the medium or the aerosol-generating substance in the stick S. Although t shown in FIG. 16, the aerosol-generating device 1 may further include a power conversion circuit (e.g., DC-to-DC converter) configured to convert the power of the power supply 11 and supply the converted power to the cartridge heater 24 and/or the heater 18. In addition, if the aerosol-generating device 1 generates an aerosol in an induction heating way, the aerosol-generating device 1 may further include a DC-to-AC converter configured to convert direct current power of the power supply 11 into alternating current power.

The controller 12, the sensor 13, the output unit 14, the input unit 15, the communication unit 16, and the memory 17 may perform functions using power received from the power supply 11. Although not shown in FIG. 16, the aerosol-generating device may further include a power conversion circuit configured to convert the power of the power supply 11 and supply the converted power to the respective components, for example, a low dropout (LDO) circuit or a voltage regulator circuit. In addition, although not shown in FIG. 16, a noise filter may be provided between the power supply 11 and the heater 18. The noise filter may be a low-pass filter. The low-pass filter may include at least one inductor and a capacitor. The cutoff frequency of the low-pass filter may correspond to the frequency of a high-frequency switching current applied from the power supply 11 to the heater 18. The low-pass filter may prevent high-frequency noise components from being applied to the sensor 13, for example, the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome. However, the disclosure is not limited thereto. In addition, the heater 18 may be implemented as a metal wire, a metal plate on which an electrically conductive track is disposed, or a ceramic heating element. However, the disclosure is not limited thereto.

In another embodiment, the heater 18 may be an induction heater. For example, the heater 18 may include a susceptor configured to generate heat through a magnetic field applied by a coil, thereby heating the aerosol-generating substance.

The input unit 15 may receive information input from the user or may output information to the user. For example, the input unit 15 may be a touch panel. The touch panel may include at least one touch sensor configured to detect touch. For example, the touch sensor may include a capacitive touch sensor, a resistive touch sensor, a surface acoustic wave touch sensor, an infrared touch sensor, etc. However, the disclosure is not limited thereto.

The display 141 and the touch panel may be implemented as an integrated panel. For example, the touch panel may be inserted into the display 141 (on-cell type touch panel or in-cell type touch panel). For example, the touch panel may be added onto the display 141 (add-on type touch panel).

Meanwhile, the input unit 15 may include a button, a keypad, a dome switch, a jog wheel, a jog switch, etc. However, the disclosure is not limited thereto.

The memory 17 may be hardware storing various pieces of data processed in the aerosol-generating device 1. The memory 17 may store data processed and to be processed by the controller 12. The memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. The memory 17 may store data on an operation time of the aerosol-generating device 1, the maximum number of puffs, the current number of puffs, at least one temperature profile, and the user's smoking pattern.

The communication unit 16 may include at least one component for communication with other electronic devices. For example, the communication unit 16 may include at least one of a short-range communication unit or a wireless communication unit.

The short-range communication unit may include a Bluetooth communication unit, a Bluetooth low energy (BLE) communication unit, a near-field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, etc. However, the disclosure is not limited thereto.

The wireless communication unit may include a cellular network communication unit, an Internet communication unit, a computer network (e.g., LAN or WAN) communication unit, etc. However, the disclosure is not limited thereto.

Although not shown in FIG. 16, the aerosol-generating device 1 may further include a connection interface such as a universal serial bus (USB) interface, and may be connected to other external devices through the connection interface such as a USB interface to transmit and receive information or charge the power supply 11.

The controller 12 may control overall operation of the aerosol-generating device 1. In an embodiment, the controller 1 may include at least one processor. The processor may be implemented as an array of a plurality of logic gates or may be implemented as a combination of a general-purpose microprocessor and a memory in which a program executable in the microprocessor is stored. Also, it will be understood by those skilled in the art that the processor can be implemented in other forms of hardware.

The controller 12 may control the supply of power from the power supply 11 to the heater 18 to control the temperature of the heater 18. The controller 12 may control the temperature of the cartridge heater 24 and/or the heater 18 based on the temperature of the cartridge heater 24 and/or the heater 18 detected by the temperature sensor 131. The controller 12 may control the power supplied to the cartridge heater 24 and/or the heater 18 based on the temperature of the cartridge heater 24 and/or the heater 18. For example, the controller 12 may determine a target temperature of the cartridge heater 24 and/or the heater 18 based on the temperature profile stored in the memory 17.

The aerosol-generating device 1 may include a power supply circuit (not shown) electrically connected to the power supply 11 between the power supply 11 and the cartridge heater 24 and/or the heater 18. The power supply circuit may be electrically connected to the cartridge heater 24, the heater 18, or the induction coil 181. The power supply circuit may include at least one switching element. The switching element may be implemented as a bipolar junction transistor (BJT), a field effect transistor (FET), or the like. The controller 12 may control the power supply circuit.

The controller 12 may control switching of the switching element of the power supply circuit to control the supply of power. The power supply circuit may be an inverter configured to convert direct current power output from the power supply 11 into alternating current power. For example, the inverter may be composed of a full-bridge circuit or a half-bridge circuit including a plurality of switching elements.

The controller 12 may turn on the switching element so that power is supplied from the power supply 11 to the cartridge heater 24 and/or the heater 18. The controller 12 may turn off the switching element so that the supply of power to the cartridge heater 24 and/or the heater 18 is interrupted. The controller 12 may control the frequency and/or the duty ratio of the current pulse input to the switching element to control the current supplied from the power supply 11.

The controller 12 may control switching of the switching element of the power supply circuit to control the voltage output from the power supply 11. The power conversion circuit may convert the voltage output from the power supply 11. For example, the power conversion circuit may include a buck-converter configured to step down the voltage output from the power supply 11. For example, the power conversion circuit may be implemented as a buck-boost converter, a Zener diode, or the like.

The controller 12 may control on/off operation of the switching element included in the power conversion circuit to control the level of the voltage output from the power conversion circuit. If the switching element is maintained in an on state, the level of the voltage output from the power conversion circuit may correspond to the level of the voltage output from the power supply 11. The duty ratio for the on/off operation of the switching element may correspond to a ratio of the voltage output from the power conversion circuit to the voltage output from the power supply 11. As the duty ratio for the on/off operation of the switching element decreases, the level of the voltage output from the power conversion circuit may decrease. The heater 18 may be heated based on the voltage output from the power conversion circuit.

The controller 12 may control the supply of power to the heater 18 using at least one of a pulse width modulation (PWM) scheme or a proportional-integral-differential (PID) scheme.

For example, the controller 12 may perform control using the PWM scheme such that a current pulse having a predetermined frequency and a predetermined duty ratio is supplied to the heater 18. The controller 12 may control the frequency and the duty ratio of the current pulse to control the power supplied to the heater 18.

For example, the controller 12 may determine, based on the temperature profile, a target temperature to be controlled. The controller 12 may control the power supplied to the heater 18 using the PID scheme, which is a feedback control scheme using a difference value between the temperature of the heater 18 and the target temperature, a value obtained by integrating the difference value with respect to time, and a value obtained by differentiating the difference value with respect to time.

The controller 12 may prevent the cartridge heater 24 and/or the heater 18 from overheating. For example, the controller 12 may control operation of the power conversion circuit such that the supply of power to the cartridge heater 24 and/or the heater 18 is interrupted when the temperature of the cartridge heater 24 and/or the heater 18 exceeds a predetermined limit temperature. For example, the controller 12 may reduce the amount of power supplied to the cartridge heater 24 and/or the heater 18 by a predetermined ratio when the temperature of the cartridge heater 24 and/or the heater 18 exceeds a predetermined limit temperature. For example, when the temperature of the cartridge heater 24 exceeds a limit temperature, the controller 12 may determine that the aerosol-generating substance contained in the cartridge 19 has been exhausted and may interrupt the supply of power to the cartridge heater 24.

The controller 12 may control charging/discharging of the power supply 11. The controller 12 may check the temperature of the power supply 11 based on an output signal from the temperature sensor 131.

If a power line is connected to a battery terminal of the aerosol-generating device 1, the controller 12 may determine whether the temperature of the power supply 11 is equal to or higher than a first limit temperature, which is a reference temperature at which charging of the power supply 11 is interrupted. When the temperature of the power supply 11 is lower than the first limit temperature, the controller 12 may perform control such that the power supply 11 is charged based on a predetermined charging current. When the temperature of the power supply 11 is equal to or higher than the first limit temperature, the controller 12 may interrupt charging of the power supply 11.

When the aerosol-generating device 1 is in an on state, the controller 12 may determine whether the temperature of the power supply 11 is equal to or higher than a second limit temperature, which is a reference temperature at which discharging of the power supply 11 is interrupted. When the temperature of the power supply 11 is lower than the second limit temperature, the controller 12 may perform control such that the power stored in the power supply 11 is used. When the temperature of the power supply 11 is equal to or higher than the second limit temperature, the controller 12 may interrupt use of the power stored in the power supply 11.

The controller 12 may calculate or determine the remaining amount of power stored in the power supply 11. For example, the controller 12 may calculate or determine the remaining capacity of the power supply 11 based on a voltage and/or current detection value of the power supply 11.

The controller 12 may determine whether the stick S is inserted into the insertion space using the insertion detection sensor 133. The controller 12 may determine that the stick S has been inserted based on an output signal from the insertion detection sensor 133. Upon determining that the stick S has been inserted into the insertion space, the controller 12 may perform control such that power is supplied to the cartridge heater 24 and/or the heater 18. For example, the controller 12 may supply power to the cartridge heater 24 and/or the heater 18 based on the temperature profile stored in the memory 17.

The controller 12 may determine whether the stick S is removed from the insertion space. For example, the controller 12 may determine whether the stick S is removed from the insertion space using the insertion detection sensor 133. For example, the controller 12 may determine that the stick S has been removed from the insertion space when the temperature of the heater 18 is equal to or higher than a limit temperature or when the temperature change slope of the heater 18 is equal to or greater than a predetermined slope. Upon determining that the stick S has been removed from the insertion space, the controller 12 may interrupt the supply of power to the cartridge heater 24 and/or the heater 18.

The controller 12 may control a power supply time and/or the amount of power supplied to the heater 18 depending on the state of the stick S detected by the sensor 13. The controller 12 may check, based on a look-up table, a level range within which the level of a signal from the capacitance sensor is included. The controller 12 may determine the amount of moisture in the stick S based on the checked level range.

When the stick S is in a highly humid state, the controller 12 may control a time during which power is supplied to the heater 18 to increase a preheating time of the stick S compared to when the stick S is in a normal state.

The controller 12 may determine whether the stick S inserted into the insertion space is a reused stick using the reuse detection sensor 134. For example, the controller 12 may compare a sensing value of a signal from the reuse detection sensor with a first reference range within which the first color is included, and may determine that the stick S is not a reused stick when the sensing value is within the first reference range. For example, the controller 12 may compare a sensing value of a signal from the reuse detection sensor with a second reference range within which the second color is included, and may determine that the stick S is a reused stick when the sensing value is within the second reference range. Upon determining that the stick S is a reused stick, the controller 12 may interrupt the supply of power to the cartridge heater 24 and/or the heater 18.

The controller 12 may determine whether the aerosol-generating substance in the cartridge 19 is exhausted. For example, the controller 12 may apply power to preheat the cartridge heater 24 and/or the heater 18, and may determine whether the temperature of the cartridge heater 24 exceeds a limit temperature in a preheating section. When the temperature of the cartridge heater 24 exceeds the limit temperature, the controller 12 may determine that the aerosol-generating substance in the cartridge 19 has been exhausted. Upon determining that the aerosol-generating substance in the cartridge 19 has been exhausted, the controller 12 may interrupt the supply of power to the cartridge heater 24 and/or the heater 18.

The controller 12 may make a determination as to a user puff using the puff sensor 132. For example, the controller 12 may determine, based on a sensing value of a signal from the puff sensor, whether a puff occurs. For example, the controller 12 may determine the intensity of a puff based on a sensing value of a signal from the puff sensor 132. When the number of puffs reaches a predetermined maximum number of puffs or when no puff is detected for a predetermined time period or longer, the controller 12 may interrupt the supply of power to the cartridge heater 24 and/or the heater 18.

The controller 12 may control the output unit 14 based on a result of detection by the sensor 13. For example, when the number of puffs counted through the puff sensor 132 reaches a predetermined number, the controller 12 may notify the user that operation of the aerosol-generating device 1 will end soon through at least one of the display 141, the haptic unit 142, or the sound output unit 143. For example, upon determining that the stick S is not present in the insertion space, the controller 12 may notify the user of the determination result through the output unit 14. For example, upon determining that the cartridge 19 and/or the upper case has not been mounted, the controller 12 may notify the user of the determination result through the output unit 14. For example, the controller 12 may transmit information about the temperature of the cartridge heater 24 and/or the heater 18 to the user through the output unit 14.

Upon determining that a predetermined event has occurred, the controller 12 may store a history of the corresponding event in the memory 17 and may update the history. The event may include events performed in the aerosol-generating device 1, such as detection of insertion of the stick S, commencement of heating of the stick S, detection of puff, termination of puff, detection of overheating of the cartridge heater 24 and/or the heater 18, detection of application of overvoltage to the cartridge heater 24 and/or the heater 18, termination of heating of the stick S, on/off operation of the aerosol-generating device 1, commencement of charging of the power supply 11, detection of overcharging of the power supply 11, and termination of charging of the power supply 11. The history of the event may include the occurrence date and time of the event and log data corresponding to the event. For example, when the predetermined event is detection of insertion of the stick S, the log data corresponding to the event may include data on a value detected by the insertion detection sensor 133. For example, when the predetermined event is detection of overheating of the cartridge heater 24 and/or the heater 18, the log data corresponding to the event may include data on the temperature of the cartridge heater 24 and/or the heater 18, the voltage applied to the cartridge heater 24 and/or the heater 18, and the current flowing through the cartridge heater 24 and/or the heater 18.

The controller 12 may perform control for formation of a communication link with an external device such as a user's mobile terminal. Upon receiving data on authentication from an external device via the communication link, the controller 12 may release restriction on use of at least one function of the aerosol-generating device 1. Here, the data on authentication may include data indicating completion of user authentication for the user corresponding to the external device. The user may perform user authentication through the external device. The external device may determine, based on the user's birthday or an identification number indicating the user, whether the user data is valid, and may receive data on the authority for use of the aerosol-generating device 1 from an external server. The external device may transmit data indicating completion of user authentication to the aerosol-generating device 1 based on the data on the use authority. When the user authentication is completed, the controller 12 may release restriction on use of at least one function of the aerosol-generating device 1. For example, when the user authentication is completed, the controller 12 may release restriction on use of a heating function for supplying power to the heater 18.

The controller 12 may transmit data on the state of the aerosol-generating device 1 to the external device through the communication link established with the external device. Based on the received state data, the external device may output the remaining capacity of the power supply 11 or the operation mode of the aerosol-generating device 1 through a display of the external device.

The external device may transmit a location search request to the aerosol-generating device 1 based on an input for commencement of search for the location of the aerosol-generating device 1. Upon receiving the location search request from the external device, the controller 12 may perform control, based on the received location search request, such that at least one of the output devices performs operation corresponding to location search. For example, the haptic unit 142 may generate vibration in response to the location search request. For example, the display 141 may output objects corresponding to location search and termination of search in response to the location search request.

Upon receiving firmware data from the external device, the controller 12 may perform control such that the firmware is updated. The external device may check the current version of the firmware of the aerosol-generating device 1 and may determine whether there is a new version of firmware. Upon receiving an input requesting firmware download, the external device may receive new version of firmware data and may transmit the new version of firmware data to the aerosol-generating device 1. Upon receiving the new version of firmware data, the controller 12 may perform control h that the firmware of the aerosol-generating device 1 is updated.

The controller 12 may transmit data on a value detected by the at least one sensor 13 to an external server (not shown) through the communication unit 16, and may receive, from the server, and store a learning model generated by learning the detected value through machine learning such as deep learning. The controller 12 may perform operation of determining the user's puff pattern and operation of generating the temperature profile using the learning model received from the server. The controller 12 may store data on the value detected by the at least one sensor 13 and data for training an artificial neural network (ANN) in the memory 17. For example, the memory 17 may store a database for each of the components provided in the aerosol-generating device 1 and weights and biases constituting the structure of the artificial neural network (ANN) in order to train the artificial neural network (ANN). The controller 12 may learn data on the value detected by the at least one sensor 13, the user's puff pattern, and the temperature profile, which are stored in the memory 17, and may generate at least one learning model used to determine the user's puff pattern and to generate the temperature profile.

As described above, according to at least one of the embodiments of the present disclosure, because the heat spreader is in contact with the circuit board connected to at least one sensor and extends in a direction away from the heater, heat generated by the heater and transferred to the sensor may be spread, thereby minimizing increase in temperature of the sensor.

According to at least one of the embodiments of the present disclosure, because the heat spreader is disposed in contact with a surface of the circuit board opposite a surface on which the sensors are disposed, the structure of the heat spreader may be simplified.

According to at least one of the embodiments of the present disclosure, because the heat spreader is bent in a shape corresponding to the bent shape of the circuit board, a contact area between the heat spreader and the circuit board may increase, and accordingly, heat may be effectively transferred from the sensor to the heat spreader.

According to at least one of the embodiments of the present disclosure, because the heat spreader extends to a lower position than the heater, heat generated by the heater and transferred to the sensor may be delivered or spread in a direction away from the heater and the sensor.

According to at least one of the embodiments of the present disclosure, because the heat spreader is disposed adjacent to the inflow passage, the heat spreader may be cooled by external air flowing through the inflow passage.

According to at least one of the embodiments of the present disclosure, because at least one heat sink is disposed outside the heat spreader, heat emitted from the heat spreader may be effectively delivered to the outside of the device.

According to at least one of the embodiments of the present disclosure, because the TIM is disposed between the heat spreader and the body casing and is in contact with the heat spreader and the body casing, heat emitted from the heat spreader may be effectively transferred to other structures in the device.

Referring to FIGS. 1 to 16, an aerosol-generating device 1 in accordance with one aspect of the present disclosure may include a body 10 including an insertion space 43 with one side open, a heater 18 configured to heat the insertion space 43, at least one sensor 132 or 133 disposed adjacent to the insertion space 43, a circuit board 510 on which the at least one sensor 132 or 133 is disposed, and a heat spreader 520 in contact with the circuit board 510. At least a portion of the heat spreader 520 may extend in a direction away from the heater 18.

In addition, in accordance with another aspect of the present disclosure, the at least one sensor 132 or 133 may include a stick detection sensor 133 configured to detect a stick received in the insertion space 43 and a puff sensor 132 in communication with the insertion space 43. The stick detection sensor 133 may be disposed to face the insertion space 43, and the puff sensor 132 may be disposed to face in a direction intersecting with the facing direction of the stick detection sensor 133.

In addition, in accordance with another aspect of the present disclosure, the stick detection sensor 133 and the puff sensor 132 may be disposed on the same surface of the circuit board 510 in the thickness direction of the circuit board 510, and the heat spreader 520 may be in contact with a surface of the circuit board 510 opposite to the surface having the stick detection sensor 133 and the puff sensor 132 disposed thereon.

In addition, in accordance with another aspect of the present disclosure, the circuit board 510 may include a first connection portion 515 bent between the stick detection sensor 133 and the puff sensor 132, and the heat spreader 520 may be bent in a shape corresponding to the bent shape of the first connection portion 515.

In addition, in accordance with another aspect of the present disclosure, the circuit board 510 may include a second connection portion 516 spaced apart from the first connection portion 515 and bent in a direction intersecting with the bent direction of the first connection portion 515 and an extending portion 513 elongated from the second connection portion 516 in one direction. The heat spreader 520 may be bent in a shape corresponding to the bent shape of the second connection portion 516 and may be elongated in a shape corresponding to the extending shape of the extending portion 513.

In addition, in accordance with another aspect of the present disclosure, the heat spreader 520 may extend to a position below the heater 18 in the longitudinal direction of the insertion space 43.

In addition, in accordance with another aspect of the present disclosure, the aerosol-generating device may include an inflow passage P that is in communication with the insertion space 43 and receives external air, and the heat spreader 520 may be disposed adjacent to the inflow passage P.

In addition, in accordance with another aspect of the present disclosure, the aerosol-generating device may include a body casing 111 disposed inside the body 10, and the inflow passage P may be defined in the body casing 111. The heat spreader 520 may be disposed in the body casing 111 and may be in contact with one side of the body casing 111.

In addition, in accordance with another aspect of the present disclosure, the aerosol-generating device may include at least one heat sink 300 or 400 disposed in the body casing 111 and disposed outside the heat spreader 520 in the radial direction of the insertion space 43.

In addition, in accordance with another aspect of the present disclosure, the aerosol-generating device may include a thermal interface material (TIM) 530 or 550 that extends in the extending direction of the heat spreader 520 and is in contact with the heat spreader 520.

In addition, in accordance with another aspect of the present disclosure, the aerosol-generating device may include a body casing 111 disposed inside the body 10 and configured to support the body 10. The TIM 530 or 550 may include a surface in contact with the heat spreader 520 and an opposite surface in contact with the body casing 111.

In addition, in accordance with another aspect of the present disclosure, the body casing 111 may include a support portion 111c that protrudes toward the heat spreader 520 and is in contact with one side of the heat spreader 520, and the TIM 550 may include a recess 552 formed by one side of the TIM 550, the recess surrounding at least part of the support portion 111c.

In addition, in accordance with another aspect of the present disclosure, the circuit board 510 may include a flexible printed circuit board (FPCB), and the heat spreader 520 may be formed of a material having higher thermal conductivity than the material of the circuit board 510.

In addition, in accordance with another aspect of the present disclosure, the heat spreader 520 may include at least one of graphite, copper, gold, silver, nanocrystals, or aluminum.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device comprising:
a body comprising an insertion space with one side open;
a heater configured to heat the insertion space;
at least one sensor disposed adjacent to the insertion space;
a circuit board on which the at least one sensor is disposed; and
a heat spreader in contact with the circuit board,
wherein the heat spreader at least partially extends in a direction away from the heater.

2. The aerosol-generating device according to claim 1, wherein the at least one sensor comprises:
a stick detection sensor configured to detect a stick received in the insertion space; and
a puff sensor in communication with the insertion space,
wherein the stick detection sensor is disposed to face the insertion space, and
wherein the puff sensor is disposed to face in a direction intersecting with a facing direction of the stick detection sensor.

3. The aerosol-generating device according to claim 2, wherein the stick detection sensor and the puff sensor are disposed on the same surface of the circuit board in a thickness direction of the circuit board, and
wherein the heat spreader is in contact with a surface of the circuit board opposite to the surface having the stick detection sensor and the puff sensor disposed thereon.

4. The aerosol-generating device according to claim 2, wherein the circuit board comprises a first connection portion bent between the stick detection sensor and the puff sensor, and
wherein the heat spreader is bent in a shape corresponding to a bent shape of the first connection portion.

5. The aerosol-generating device according to claim 4, wherein the circuit board comprises:
a second connection portion spaced apart from the first connection portion and bent in a direction intersecting with a bent direction of the first connection portion; and
an extending portion elongated from the second connection portion in one direction, and
wherein the heat spreader is bent in a shape corresponding to a bent shape of the second connection portion and is elongated in a shape corresponding to an extending shape of the extending portion.

6. The aerosol-generating device according to claim 5, wherein the heat spreader extends to a position below the heater in a longitudinal direction of the insertion space.

7. The aerosol-generating device according to claim 1, comprising an inflow passage in communication with the insertion space, the inflow passage being configured to receive external air,
wherein the heat spreader is disposed adjacent to the inflow passage.

8. The aerosol-generating device according to claim 7, comprising a body casing disposed inside the body,
wherein the inflow passage is defined in the body casing, and
wherein the heat spreader is disposed in the body casing and is in contact with one side of the body casing.

9. The aerosol-generating device according to claim 8, comprising at least one heat sink disposed in the body casing and disposed outside the heat spreader in a radial direction of the insertion space.

10. The aerosol-generating device according to claim 1, comprising a thermal interface material (TIM) extending in an extending direction of the heat spreader, the TIM being in contact with the heat spreader.

11. The aerosol-generating device according to claim 10, comprising a body casing disposed inside the body, the body casing being configured to support the body,
wherein the TIM comprises a surface in contact with the heat spreader and an opposite surface in contact with the body casing.

12. The aerosol-generating device according to claim 11, wherein the body casing comprises a support portion protruding toward the heat spreader, the support portion being in contact with one side of the heat spreader, and
wherein the TIM comprises a recess formed by one side of the TIM, the recess surrounding at least part of the support portion.

13. The aerosol-generating device according to claim 1, wherein the circuit board comprises a flexible printed circuit board (FPCB), and
wherein the heat spreader is formed of a material having higher thermal conductivity than a material of the circuit board.

14. The aerosol-generating device according to claim 1, wherein the heat spreader comprises at least one of graphite, copper, gold, silver, nanocrystals, or aluminum.
